(19) United States
(12) Patent Application Publication
(10) Pub. No.: US 2010/0199351 A1
(43) Pub. Date: Aug. 5, 2010

(54) METHOD AND SYSTEM FOR SECURING VIRTUAL MACHINES BY RESTRICTING ACCESS IN CONNECTION WITH A VULNERABILITY AUDIT

(76) Inventor: Andre Protas, Newport Beach, CA (US)

Correspondence Address: Eric L. Tanezaki;STETINA BRUNDA GARRED & BRUCKER, Suite 250, 75 Enterprise, Aliso Viejo, CA, 92656, US

(21) Appl. No.: 12/363,862

(22) Filed: Feb. 2, 2009

Related U.S. Application Data
(63) Continuation-in-part of application No. 12/348,257, filed on Jan. 2, 2009.

(51) Int. Cl. G06F 21/22; G06F 15/173; G06F 9/44; G06F 17/30

(52) U.S. Cl. 726/25; 709/224; 717/168; 718/1; 707/E17.014

(57) ABSTRACT

A method and system for securing a virtual machine is disclosed. An initiation signal from the host system that is generated upon startup of the virtual machine is intercepted, and a network connection on the host system accessible by the virtual machine is restricted in response. Then, the virtual machine is queried for preexisting vulnerabilities, and such data is received. Access by the virtual machine to the network connection is controlled based upon a comparison of a security policy, which is associated with the virtual machine, to the received preexisting vulnerabilities.

### CROSS-REFERENCE TO RELATED APPLICATIONS

This continuation-in-part patent application claims the benefit of the earlier filing date of U.S. patent application Ser. No. 12/348,257, filed Jan. 2, 2009, the entire contents of which is incorporated herein by reference.

### STATEMENT RE: FEDERALLY SPONSORED RESEARCH/DEVELOPMENT

Not Applicable

### BACKGROUND

1. Technical Field

The present invention relates generally to computer network security, and more particularly, to methods and systems for securing virtual machines in a networked computing environment by restricting access in connection with a vulnerability audit.

2. Related Art

Virtualization refers broadly to the abstraction of computer resources, that is, the separation of a service or resource request from its underlying physical delivery. One common virtualization application is platform or server virtualization, in which multiple virtual machines or “guest operating systems,” along with its attendant application software, run on a single host computer. A host control application, also variously known in the art as “virtual machine monitor,” “hypervisor,” and so forth, manages the virtual machines and provides a simulated environment within which the virtual machines run.

There are two principal ways in which the host control application runs in relation to the underlying physical machine. The host control application may run natively on the host hardware, and is known as a “bare metal” architecture. One such host control application that is currently available is the ESX Server from VMWare of Palo Alto, Calif. Alternatively, the host control application may run on top of an existing operating system installation such as with the Virtual Server product from Microsoft Corporation of Redmond, Wash.

Unless specially modified for optimized execution on virtual machine hosts, each of the guest operating systems expect to run on a dedicated computer system with full access to the hardware resources of the physical machine. These hardware resources include one or more central processing units and related components such as cache memory, registers, etc., random access memory (RAM), hard disk drives, optical drives, network interface cards, and various other input/output devices such as keyboards, mice, graphics cards, etc. The hardware interrupts and exceptions that signal external events from the physical machine are also abstracted by the host control application. Essentially, the host control application emulates the underlying hardware and provides a common interface thereto for each of the virtual machines under its management.

Platform virtualization arose from the need to run multiple operating systems on a single computer, which allowed time-sharing computers to process tasks from single-tasking systems. The virtual machine architecture is highly flexible and scalable, and enhances security and reliability. One common application of virtual machines is directed to server consolidation, where various services that would otherwise require multiple computers are incorporated into one. Isolation between the servers, albeit “virtual,” is maintained because each virtual machine runs independently of others. Therefore, quality of service (QoS) isolation is achieved; a shutdown of an application in one machine does not cascade and result in the shutdown of applications in other machines. Such shutdowns may involve catastrophic failures of the application or the underlying operating system, as well as planned downtime for backup and other system maintenance. If many applications are hosted on a single platform, a failure in one application may result in the failure of the operating system, leading to a failure in the other applications that may or may not depend upon such failed applications.

Virtual machines also offer distinct advantages over hosting each individual platform on its own hardware. For instance, virtual machines can be brought online and offline more quickly, and can be easily created, copied, and backed up in the same way as ordinary data files. Cost reductions are also achieved because there is no longer a need to acquire, maintain and update expensive hardware for multiple physical servers. Corresponding cost reductions associated with decreased electrical power consumption are also realized.

An operating system, as well as the applications deployed thereon, may have one or more security vulnerabilities that can be exploited by malicious attacks to cause damage, disrupt operations (e.g. denial of service), or compromise sensitive data. The attacks are varied and range from virus and worm infections, Trojan horses, rootkits, spyware, adware, and the like, as well as targeted attempts to gain unauthorized access. Security vulnerabilities, while varied and dependent on the specific software to which it applies, include memory safety violations such as buffer overflow and dangling pointers, input validation errors, race conditions, privilege confusion errors, privilege escalation, and user interface failures. An attacker takes advantage of these vulnerabilities to gain further access privileges, allowing for harmful functionality to be invoked. Although operating systems provide basic security protections such as the enforcement of access control and ownership rights over system resources, such protections may be insufficient for serious vulnerabilities. In most cases, attacks originate through the network, and merely placing a vulnerable system online almost instantaneously subjects it to a successful attack. Oftentimes, other security systems such as firewalls, anti-virus scanners, and intrusion detection systems are concurrently deployed in a multi-layered approach.

Each of these security technologies serves different purposes, and one may be more appropriate in some situations over others. For example, firewalls merely examine network packets to determine whether or not to forward them on to the specified destination. Data is screened based upon domain names, Internet Protocol (IP) addresses, and can prevent low-level attacks. However, firewalls do not protect networks from system vulnerabilities and improper configurations, or malicious activity originating from within the internal network. As another example, intrusion detection systems inspect inbound and outbound network activity in order to identify suspicious patterns, but do not protect against sophisticated attacks or safeguard vulnerabilities that may be exploited by remotely executed code. Further, anti-virus scanners examine executable code on the computer system for the aforementioned malware and prevent such code from running, but would be unable to detect network-based attacks. Nevertheless, each serves an integral part in protecting the computer system.

New vulnerabilities, viruses, and other attack vectors are always being discovered, and in order to ensure the highest levels of security, computer systems must be constantly updated to prevent exploits based upon new weaknesses. Vulnerabilities are typically the result of bugs, fundamental software design issues, and/or poor configuration, and accordingly, substantial software development efforts are directed to correcting such problems through incremental revisions or patches. Detection signatures and heuristics algorithms for firewalls, anti-virus scanners, and intrusion detection systems have similarly rapid update cycles.

The security updates involving antivirus and intrusion detection signatures, operating system and application patches, and the like must be applied to each virtual machine that is on-line or capable of being brought online. Because of the limitless number of virtual machines that may be hosted in any single deployment, updating each one is a tedious and time-consuming chore, particularly at the frequency in which security updates must be made. Although many of the update functions can be automated, the process remains challenging because not all virtual machines are active at any given time, and conversely, some updates require the virtual machine to be shut down as part of the update process.

As indicated above, some virtual machines are brought online only when the current demand load requires it. Thus, many months may pass between each instantiation of the virtual machine, and consequently, many important security updates may have been missed and critical vulnerabilities may have unknowingly become exposed. Further, as vulnerability assessment (whether antivirus or intrusion detection systems) involves only the periodic scanning of the system within certain preset time windows, if the virtual machine was instantiated outside that time window, then the vulnerabilities would not be discovered. Compounding the problem is that once a vulnerable virtual machine is brought online and provided access to the network at large, it may be immediately attacked and comprise the virtual machine host.

Accordingly, there is a need in the art for an improved method for restricting network access to virtual machines.

### BRIEF SUMMARY

In accordance with one embodiment of the present invention, a method for securing a virtual machine on a host system is disclosed. The method may begin with intercepting an initiation signal from the host system that is generated upon startup of the virtual machine. A network connection on the host system is accessible by the virtual machine. Thereafter, the method continues with restricting the network connection to the virtual machine. This restriction may be placed in response to the initiation signal. The method may also include a step of querying the virtual machine for preexisting vulnerabilities, followed by a step of receiving the preexisting vulnerabilities from the virtual machine. The method may conclude with controlling access by the virtual machine to the network connection on the host system. The access control may be based upon a comparison of a security policy to the received preexisting vulnerabilities. The security policy may include vulnerability definitions associated with the virtual machine.

Another embodiment of the present invention contemplates a virtual machine vulnerability assessment system. This system may include a monitor module in communication with a host system for a virtual machine. The host system may also be in communication with the virtual machine. A startup signal generated at the instantiation of the virtual machine may be receivable by the monitor module. The system may also include a scanning engine that is activatable by the monitor module. This scanning engine, in turn, may be in communication with the virtual machine to detect vulnerabilities thereof. The scanning engine may utilize a security policy that is associated therewith, and may include a plurality of vulnerability definitions. A policy execution module that is in communication with the scanning engine may control access to the network interface from the virtual machine based upon a correlation of the detected vulnerabilities to the vulnerability definitions.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram of an exemplary host system in accordance with an embodiment of the present invention running a plurality of virtual machines in a hosted environment;

FIG. 2 is a block diagram of another exemplary host system running a plurality of virtual machines in a “bare-metal” or native configuration;

FIG. 3 is a block diagram illustrating an exemplary network topology;

FIG. 4 is a flowchart depicting steps in a method for securing a virtual machine in accordance with an embodiment of the present invention;

FIG. 5 is a block diagram of a virtual machine vulnerability assessment system and the virtual machine secured thereby;

FIGS. 6a-6c are block diagrams of the virtual machine vulnerability assessment system variously utilizing several exemplary modalities to detect the initiation of the virtual machine; and

FIG. 7 is a flowchart illustrating the overall sequence of steps in an exemplary embodiment of the present invention.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

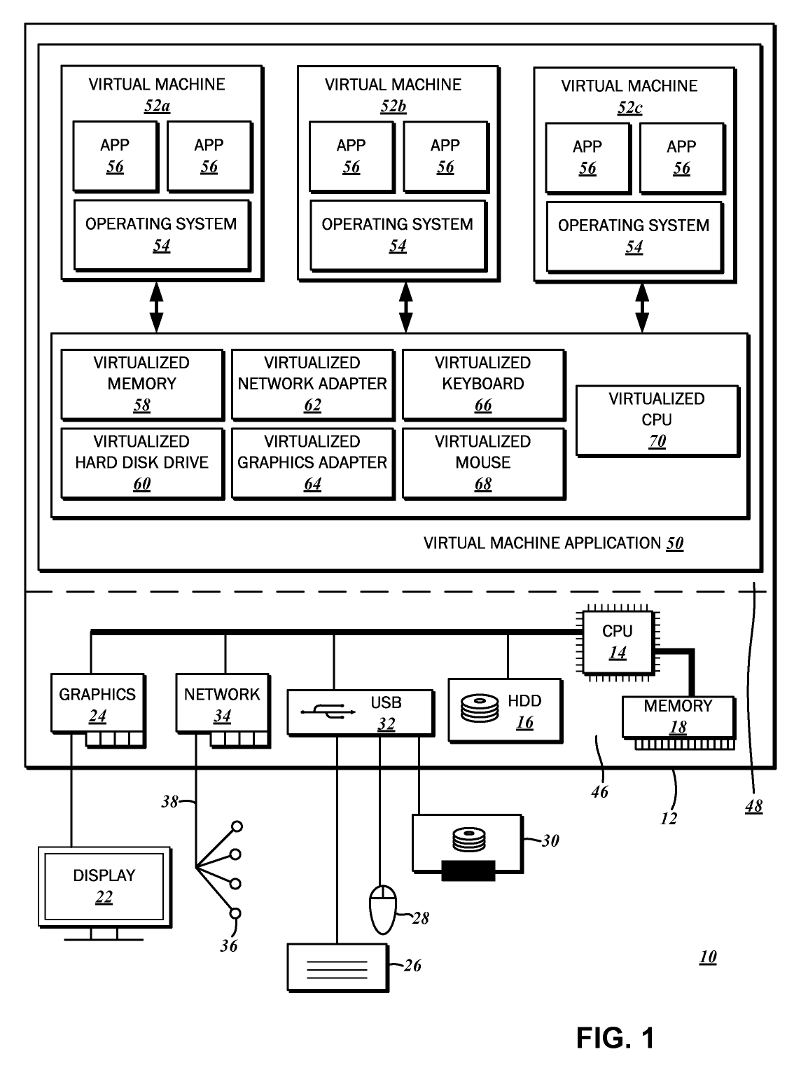

With reference to the block diagram of FIG. 1, a first exemplary virtual machine environment 10 includes a general-purpose host computer platform 12. Although not limited to the specific example shown herein, the host computer platform 12 includes a central processing unit (CPU) 14 that executes programmed instructions in cooperation with various components of the same. System and user data, as well as the programmed instructions, are stored in a permanent storage device or hard disk drive 16, or a random access memory (RAM) 18. The hard disk drive 16, along with the other devices described more fully below, communicate with the CPU 14 via a system bus 20. However, because data and instructions stored in the RAM 18 must be accessed more quickly, there may be a separate segment of the system bus 20 with a higher clock speed, also known as “north bridge. The slower segment of the system bus 20 is known as “south bridge.”

Output resulting from the execution of instructions on the CPU 14 may be graphically displayed on a monitor 18. In further detail, the monitor 18 may be a Cathode Ray Tube (CRT) device, a Liquid Crystal Display (LCD) device or any other suitable display device type. The CPU 14 may output general instructions on what to display, while a graphics processor 24 handles the specific signaling of pixels of the monitor 22. As previously noted, the graphics processor 24 transmits data to and receives data from the CPU 14 via the system bus 20.

Another component of the exemplary host computer platform 12 is a keyboard 26, a mouse 28, and one or more external data storage devices 30. Each of these components is connected to the host computer platform 12 via a Universal Serial Bus (USB) interface 32, which in turn communicates with the CPU 14 via the system bus 20. As is well recognized, the keyboard 26 and the mouse 28 are inputs to the CPU 14 that modify or otherwise direct the execution of the preprogrammed instructions. It is understood that the external data storage devices 30 include optical media such as CD-ROMs, DVDs, and so forth, as well as flash memory devices, and external hard drives. Other devices besides those mentioned above are connectible to the host computer platform 12 via the USB interface 32, such as microphones, game pads, image scanners, and so forth.

The host computer platform 12 may include a network adapter 34 for communicating with one or more remote computers or nodes 36 on a network 38. As referenced herein, the network 38 may be a local area network (LAN) in which each of the nodes 36 with which the host computer platform 12 communicates are in relative physical proximity to each other. Such networks typically utilize Ethernet, and to a lesser extent, WiFi connections; the network adapter 34 is understood to conform to the standards therefor. Alternatively, the network 38 may be a wide area network (WAN) where the nodes 36 are dispersed over vast geographic distances.

As is more typical, however, the network 38 may be a combination of various local sub-networks dispersed across the Internet, where each local sub-network is managed and operated by a single entity. Referring to the example network diagram of FIG. 3, a first group of nodes 36a-36c may constitute an internal network 40 of an enterprise, with a single connection to the Internet 42 being established via a gateway 43. One of the nodes 36a-36c may be a server that provides data access to a client computer 44, which is outside of the internal network 40. The client computer 44 is also connected to the Internet 42, through which communications are established to nodes 36a-36c. It will be appreciated by those having ordinary skill in the art that the network 38 is referenced expansively to encompass any type of network topology and connectivity modalities known or developed in the future.

Along these lines, it will also be appreciated that while the following description of the invention refers to steps carried out in an exemplary host computer platform 12 and logical modules having particular features embodied thereon, any other data processing device having similar features may be substituted without departing from the scope of the invention. Furthermore, the specifics of the host computer platform 12 described above are not intended to be limiting, and any combination of the above components may constitute the same. By way of example, a typical application of the methods and systems of the present invention involves server systems, where peripheral devices such as the keyboard 26, the mouse 28, or even the monitor 22 are not necessary. However, the present inventive methods and systems find equal application in a system that includes the peripheral devices, such as desktop computers.

In general, the functionality of the host computer platform 12 is implemented in one or more layered levels of abstraction. Thus, implementation specifics at one abstraction level can be isolated from other levels and requiring only a predefined interface to access its functionality. At the base layer are the physical hardware resources 46, in which the basic functionality is governed in terms of electrical signals and responses thereto. A combination of the various electrical signals is representative of processor instructions being executed by the CPU 14. In turn, a combination of the processor instructions is representative of higher-level, user-programmed instructions, or software. In a general-purpose computer, the system architecture further segregates software into different abstraction levels. At the lowest layer, the operating system provides a set of modules for accessing the file system and other hardware such as the graphics subsystem, and also includes time sharing and memory management features, among many others. Application software built to run on the specific operating system interfaces with those modules to execute the lower-level functions provided thereby.

In the first exemplary embodiment shown in FIG. 1, a host operating system 48 is installed on the host computer platform 12, as is conventional. The host operating system 48 provides direct access to the various hardware components of the host computer platform 12 through its lower-level system modules. It is contemplated that the host operating system 48 is one of several widely utilized operating systems that have virtual machine applications, for example, Microsoft Windows, Apple MacOS X, Linux, and so forth.

Virtualization is achieved in this first embodiment through a virtual machine application 50 installed and running on the host operating system 48. The virtual machine application 50, also referred to in the art as a hypervisor, hosts one or more virtual machines 52, including a first virtual machine 52a, a second virtual machine 52b, and a third virtual machine 52c. Each of the virtual machines includes an installation of a guest operating system 54, with one or more applications 56 running thereon. As referenced herein, the term application is understood to encompass any set of executable software instructions, as well as the data utilized thereby. In the context of a typical virtual machine deployment, the application 56 may be, for example a web server, a database server, or a mail server, though single user applications such as word processors, spreadsheets, and the like are also intended to be encompassed. The guest operating system 54 may be any one of numerous operating systems available, and generally, selected to correspond to the particular requirements of the applications 56 running thereon.

The virtual machine application 50 emulates the various hardware resources 46 of the host computer platform 12, and includes, for example, a virtualized memory 58, a virtualized hard drive 60, a virtualized network adapter 62, a virtualized graphics processor 64, a virtualized keyboard 66, a virtualized mouse 68, and a virtualized CPU 70. More particularly, the host operating system 48 interfaces with the virtual machine application 50, and translates requests from the virtual machines 52 to the host operating system 48, and ultimately the hardware resources 46 of the host computer platform 12. It appears to each of the guest operating systems 54 that it has sole access to the hardware resources 46 while being shared amongst the virtual machines 52. With regard to the virtualized network adapter 62, it is understood that one virtual machine running on the host computer 12 can communicate with another virtual machine on the same host computer 12, as well as other machines on the network 38, whether virtual or physical. As such, a network communications link can be established within the virtual machine application 50. In addition to the allocation of shared hardware resources 46, execution scheduling, and memory management, the virtual machine manager 72 initiates the startup, suspension, restart, and shutdown of the virtual machines 52 and performs various maintenance functions.

The virtualization framework of the aforementioned first embodiment is also known as a hosted architecture. There are a number of different virtual machine applications 50 available, including the VMWare Server and Workstation products from VMWare, Inc. of Palo Alto, Calif., as well as the Virtual Server product from Microsoft Corporation of Redmond, Wash. Conventionally, the collection of data comprising the virtual machine 52, including the guest operating system and the applications 56, are encapsulated into one or more files stored on and readable from the file system of the host operating system 48.

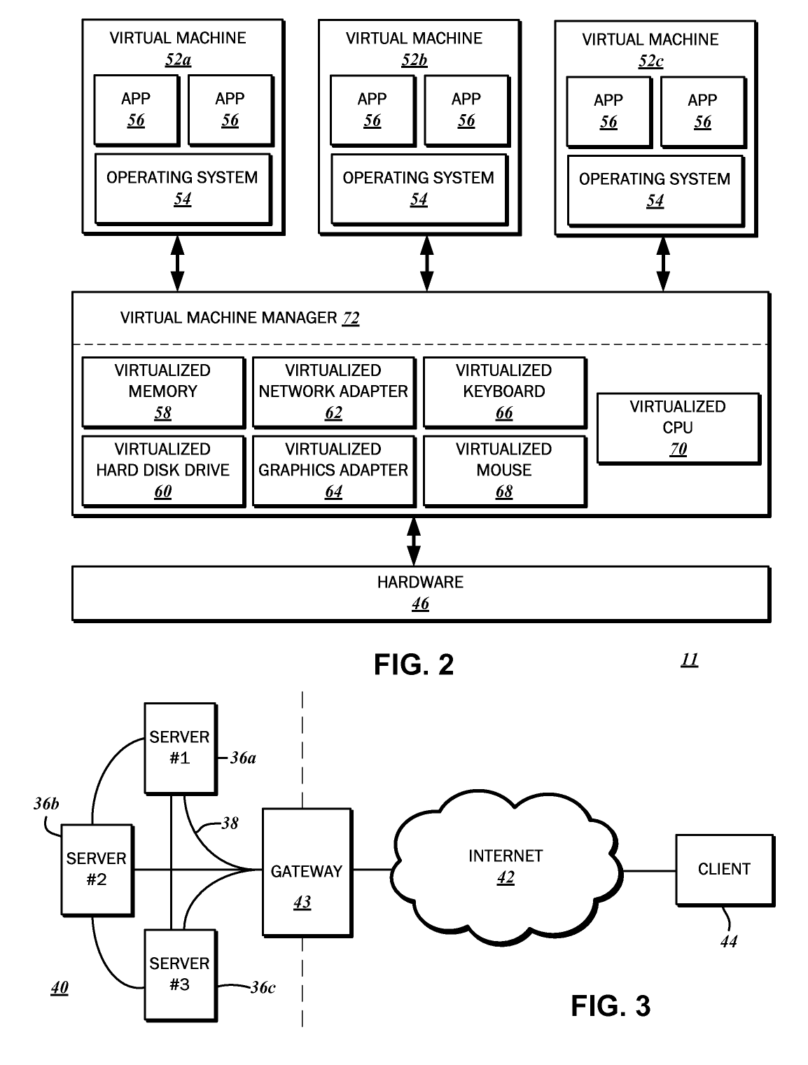

As an alternative to the hosted architecture, another virtualization framework known as a native or “bare metal” architecture may be utilized in accordance with an exemplary second embodiment of a virtual machine environment 11. One commercial implementation of this architecture is the ESX Server product also from VMWare, Inc. Referring to the block diagram of FIG. 2, a second variant of a virtual machine manager 72 or hypervisor provides the virtualization layer immediately above the hardware resources 46. Since the virtual machine manager 72 has direct access to the hardware resources 46 rather than through the host operating system 48 as in the hosted architecture, there are substantial speed and efficiency improvements.

In other respects, the operation of the individual virtual machines 52 is almost identical to that of the hosted architecture, above. For example, the virtual machine manager 72 likewise has interfaces to the virtualized hardware, including the virtualized memory 58, the virtualized hard drive 60, the virtualized network adapter 62, the virtualized graphics processor 64, the virtualized keyboard 66, the virtualized mouse 68, and the virtualized CPU 70. The guest operating system 54 runs on the virtual machine manager 72, and in turn, various applications 56 run on the guest operating system 54.

As referenced herein, the virtual machine manager 72 and the virtual machine application 50 are understood to have similar functionality with respect to the management of the virtual machines 52. Accordingly, when referring to certain functions that are performed by the virtual machine manager 72 in the following detailed description, it is to be understood that such functions could also be performed by the virtual machine application 50. The difference between the virtual machine manager 72 and the virtual machine application 50 is the environment within which it runs.

In addition to the hosted architecture and native architecture described above, there are other virtualization solutions with varying implementations. For example, the guest operating system 54 may be modified with the ability reference directly the hardware devices 46 without going through the host operating system 48, or even the virtual machine manager 72. The embodiments of the present invention do not depend on the any particular virtualization architecture, and are not limited thereto. The following details pertaining to aspects of the present invention will be described in the context of generic virtual machines. Those having ordinary skill in the art with knowledge of specific implementation details of various virtual machine architectures will be readily able to apply the disclosed aspects of the present invention to such implementations.

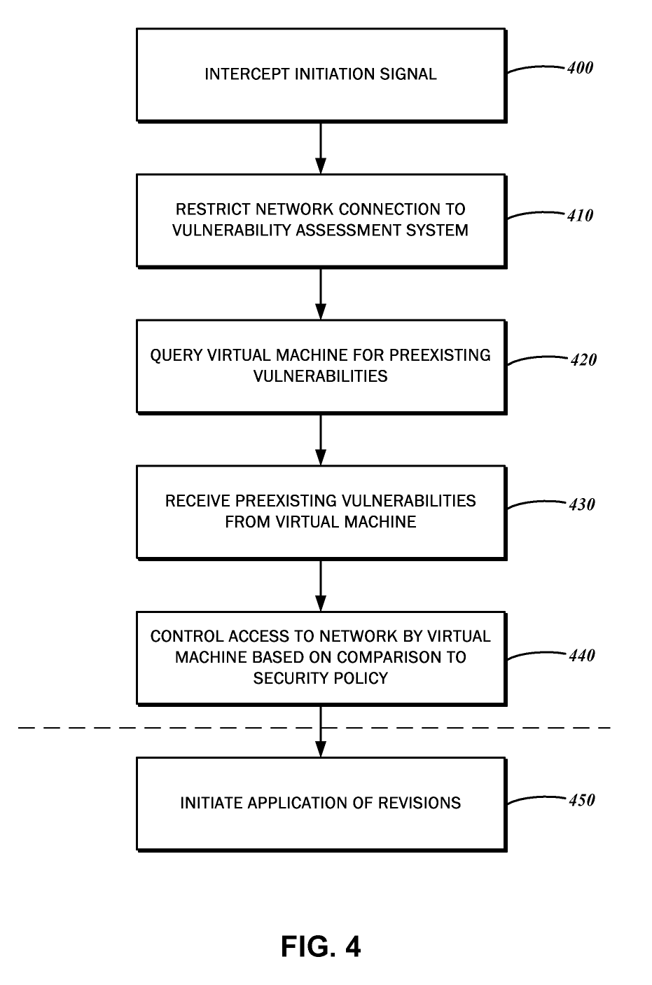

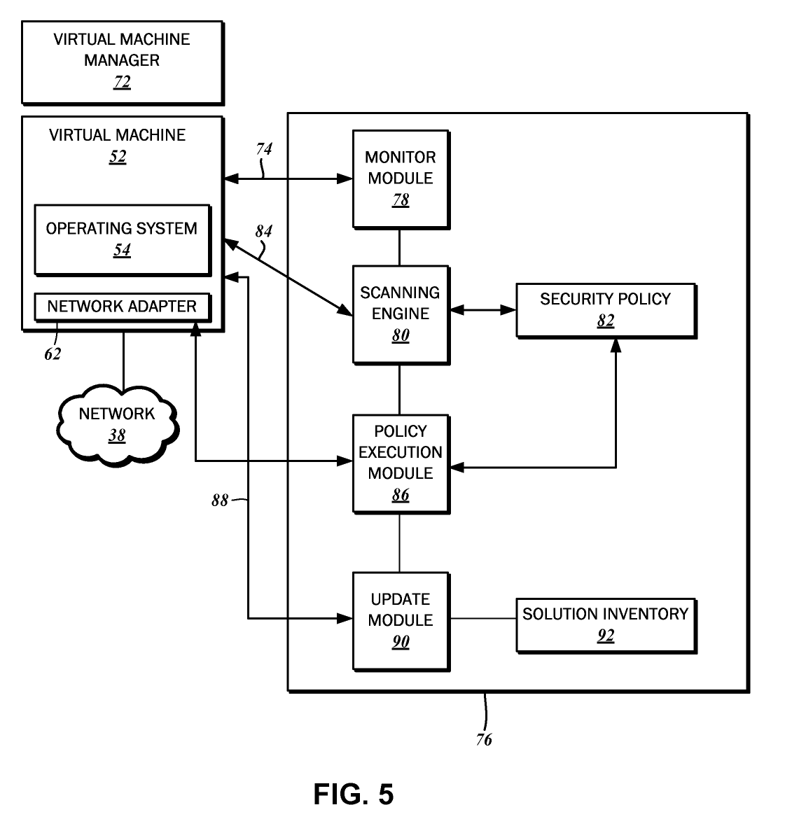

With reference to the flowchart of FIG. 4 and the block diagram of FIG. 5, a method and a system for securing the virtual machine 52 are contemplated. As indicated above, the virtual machine 52 runs within the virtual machine environment 11, and may be started, paused, resumed, and stopped by the virtual machine manager 72 at unspecified times for load balancing, disaster recovery, backup, and other such purposes. As utilized herein, starting and stopping the virtual machine 52 refers to the conventional boot-up and shutdown sequences associated with standalone computer systems where memory and execution states are cleared. In contrast, pausing and resuming are associated with halting the execution of the virtual machine 52, with the current state thereof being maintained. Resuming the virtual machine 52 after pausing restores the same to a state immediately preceding the pause.

Because there may be an extended time period between stopping and starting and/or pausing and resuming the virtual machine 52, certain aspects of the present invention contemplate verifying the security status thereof prior to permitting full access. One significant vector used for compromising the security of the virtual machine 52, and ultimately the entire virtual machine environment 11, is the connection to the network 38 over the virtualized network adapter 62. Accordingly, it is contemplated that one of the resources that are safeguarded under the present inventive method and system is the network connection. The following exemplary illustrations all relate to the securing of the network connection, though it will be appreciated that any other sensitive resource of the virtual machine 52 may be similarly secured.

The method in accordance with one embodiment of the present invention begins with a step 400 of intercepting an initiation signal 74. When the virtual machine 52 is started or resumed, various indicators thereof are activated by the guest operating system 54 or the virtual machine manager 72. A vulnerability assessment system 76, specifically, a monitor module 78 incorporated into the vulnerability assessment system 76, detects such indicators.

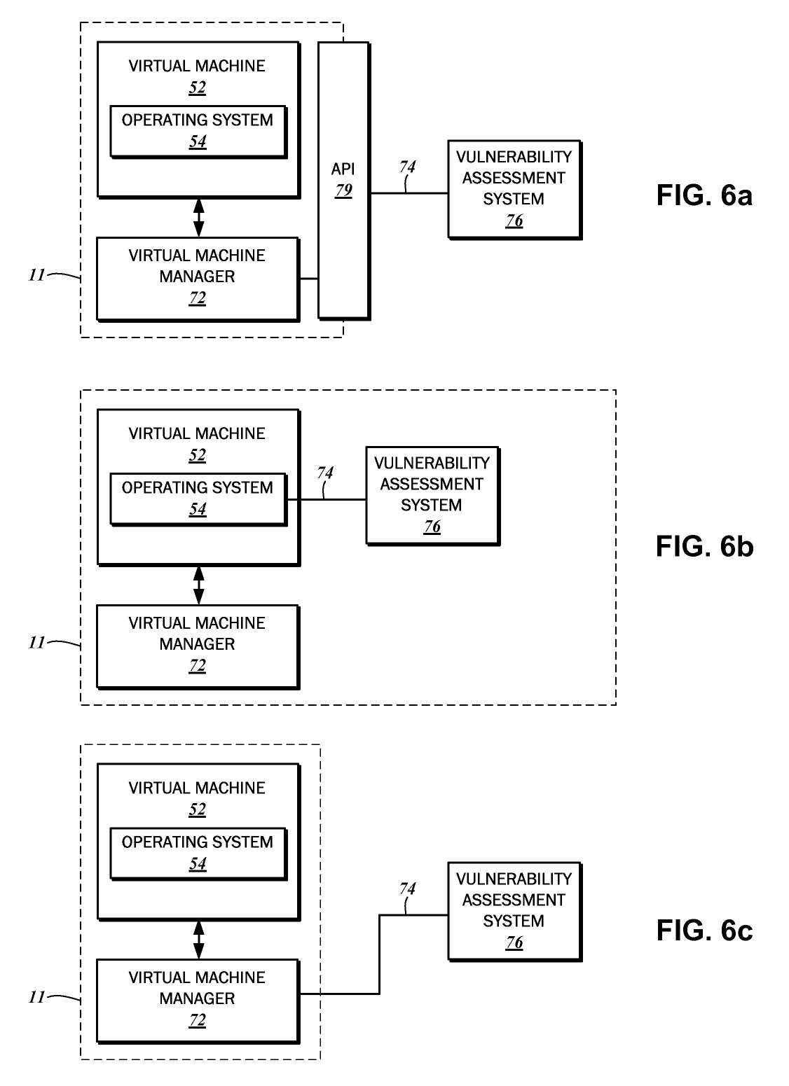

As best shown in FIG. 6a, one of the contemplated ways in which the initiation signal 74 is intercepted is via an exposed application programming interface (API) 79. Some embodiments of the virtual machine manager 72 include the API 79 to permit external control of the basic management functions provided thereby, and thus have externally accessible status variables. These status variables indicate the online status of the virtual machines 52 under the control of the virtual machine manager 72, and monitoring for changes in these status variables is understood to correspond to the interception of the initiation signal 74. The API 79 a part of the virtual machine environment 11, and not necessarily specific to the specific operating virtual machine 52 or the virtual machine manager 72. The virtual machine manager 72 controls the execution of the virtual machine 52 and signals the various events, including the aforementioned startup and resume, to the API 79. Accordingly, the vulnerability assessment system 76 may be running on another virtual machine or otherwise within the virtual machine environment 11. In such cases, the vulnerability assessment system 76 may communicate with the API 79 over a local interface in a memory of the host computer platform 12. It is also envisioned that the vulnerability assessment system 76 runs natively as a standalone executable on the host computer platform 12, or on a remote machine (whether virtual or not) capable of communicating with the virtual machine environment 11 over the interface of the virtualized network adapter 62.

Another modality for intercepting the initiation signal 74 is shown in FIG. 6b, which illustrates the vulnerability assessment system 76 in direct communication with the guest operating system 54. The vulnerability assessment 76 may be configured to hook into the virtual machine 52 to detect interrupts generated by the guest operating system 54. In this configuration, it is also contemplated that the vulnerability assessment system 76 is running within the virtual machine environment 11 as a peer of the virtual machine 52, externally in relation to the virtual machine environment 11 as a separate process on the host computer platform 12, or remotely via a network connection to the guest operating system 54.

With reference to FIG. 6c, there is shown yet another modality for intercepting the initiation signal 74. The vulnerability assessment system 76 interfaces with the virtual machine manager 72, which generates various indicators that correspond to the virtual machine 52 being started or resumed. As previously mentioned, the virtual machine manager 72 itself controls many operational aspects of the virtual machine 52. Thus, upon being configured to generate the proper indicators, the vulnerability assessment system 76 will be able to detect the same. Again, as the other configurations described above, the vulnerability assessment system 76 may run as an internal process within the virtual machine environment 11, as a local process but external to the virtual machine environment 11, or as a remote process over the network 38.

The foregoing modalities in which the initiation signal 74 is intercepted is provided by way of example only and not of limitation. It is contemplated that there may be further variations that are specific to the configuration of the virtual machine environment, and may depend on the features of the virtual machine manager 72, the host operating system 48 to the extent there is one, and the guest operating system 54. The present invention generally contemplates the detection of the starting up or resuming of the virtual machine 52 through various signals or indicators generated in response thereto by the monitor module 78, and any particular implementations therefore are deemed to be within the scope of the present invention.

Referring again to the flowchart of FIG. 4, the method continues with a step 410 of restricting the connection to the network 38 to between the virtual machine 52 and the vulnerability assessment system 76. This restriction is placed in response to a receipt of the initiation signal 74 by the monitor module 78. As noted above, one of the most common vectors through which the security of the virtual machine 52 is compromised is the network connection, and before verification, its security status is unknown by definition. As an initial step, the virtual machine 52 is prevented from communicating with any other segment of the network 38 to prevent exploit attempts. Any number of steps may be taken to restrict network access, including the temporary modification of system configuration files to prevent certain connections, filtering out incoming traffic from excluded sources at the virtual network adapter 62, and so forth.

While the network access is restricted, the method continues with a step 420 of querying the virtual machine 52 for preexisting vulnerabilities therein. According to one embodiment of the present invention, this function is performed by a scanning engine 80. It is contemplated that the monitor module 78 activates the scanning engine once the network connection is restricted in step 410. In general, the scanning engine 80 analyzes the configuration options of the virtual machines and tests for known vulnerabilities, all of which are predefined in a security policy 82. Furthermore, vulnerabilities associated with particular open network ports and services, as well as the patch status of the guest operating system 54, the applications 56, and other software such as device drivers, firmware, and the like, are queried by the scanning engine 80.

As indicated above, new vulnerabilities are frequently discovered and patches to eradicate such vulnerabilities are correspondingly updated. It is understood that the vulnerability definitions of the security policy 82 are updatable in accordance with one of numerous software update techniques known in the art (e.g., retrieving from a central database provided by a security research vendor and accessible via the Internet.)

One popular vulnerability scanner applications known in the art that incorporates the scanning engine 80 is the Retina® Network Security Scanner from eEye Digital Security of Irvine, Calif. In this regard, certain embodiments of the present inventive method and system for securing virtual machines may be incorporated into such vulnerability scanner applications. Those having ordinary skill in the art will recognized that the aforementioned vulnerabilities that may be defined in the security policy 82 are provided by way of example only, and that there are many other types of vulnerabilities for which the scanning engine 80 can query the virtual machine 52. Similarly, it will also be recognized that the scanning engine 80 is not necessarily limited to those incorporated into vulnerability scanner applications, and any other security monitoring application may be readily substituted without departing from the present invention.

Upon completing the query, the method continues with a step 430 of receiving the preexisting vulnerabilities 84 from the virtual machine 52. Specifically, the preexisting vulnerabilities 84 as matched to the security policy 82 are returned to the scanning engine 80 for additional analysis. A report of the discovered preexisting vulnerabilities may also be generated for viewing by a system administrator.

One embodiment of the present invention concludes with a step 440 of controlling access by the virtual machine 52 to the network connection. A policy execution module 86 is in communication with the scanning engine 80 to receive the preexisting vulnerabilities 84 and to determine when the querying step 420 has completed. The preexisting vulnerabilities 84 may be delivered to the policy execution module 86 as they are detected by the query and received by the scanning engine, or, in the alternative, they may be delivered after completion of the query.

The policy execution module 86 compares the received preexisting vulnerabilities 84 to the vulnerability definitions of the security policy 82, and restricts access to the network connection depending upon the results. In one configuration, the detection of even a single vulnerability may result in a failure in which further access to the network 38 is restricted. When this occurs, the virtual machine 52 can be characterized as having failed the security policy 82. Where there are no vulnerabilities detected, that is, when the virtual machine 52 passed the security policy 82, the policy execution module 86 permits unencumbered access to the network 38. There are a number of ways the connection to the network 38 may be restricted as described above, and the reverse thereof may undo the restrictions. As indicated, the monitor module 78 may modify various network configuration files, or alternatively, the policy execution module 86 may direct the guest operating system 54, the virtual network adapter 62, or the virtual machine manager 72 to effectuate such changes. The virtual machine 52 is now accessible from the network 38 with a certain level of confidence that known vulnerabilities cannot be exploited to cause harm.

It will be appreciated, however, that while some vulnerabilities are critical in that it is sound security to policy to restrict access to the network 38 while the virtual machine 52 remains exploitable, there are other less-critical vulnerabilities that do not warrant such drastic limitations. Relatedly, it will be appreciated that a combination of such less-critical vulnerabilities may accumulate to critical levels, and a certain vulnerability combined with another may be more critical than each such vulnerabilities standing alone. To fine-tune the network restrictions among all such contingencies, the vulnerability definitions may have assigned thereto a criticality level. Upon receipt of the preexisting vulnerabilities 84, the scanning engine 80 may assign each with a criticality level based upon the corresponding definition in the security policy 82. As indicated above, the assigned criticality level is understood to be appropriate for the potential harm posed, and a criticality level assigned to one received preexisting vulnerability may be different from another. Where the combined tally of the criticality levels from the received preexisting vulnerabilities 84 exceeds a combined threshold criticality level, access to the network 38 is restricted. Where the combined tally of the criticality levels is less than the combined threshold criticality level, then access to the network 38 is permitted.

The foregoing embodiment of controlling access by the virtual machine 52 to the network connection based upon variable criticality levels is presented by way of example only and not of limitation. A person of ordinary skill in the art will recognize that other modalities involving different evaluations and weighing of the preexisting vulnerabilities 84 may be substituted without departing from the present invention.

Referring again to the flowchart of FIG. 4, the method in accordance with another aspect of the present invention includes a step 450 of initiating the application of revisions 88 to the virtual machine 52. As indicated above, the preexisting vulnerabilities are typically known configuration errors, missing patches, and the like, and thus have readily available remedies that can be applied to the virtual machine 52. It is contemplated that the vulnerability definitions in the security policy 82 have a corresponding solution or revision 88 that can corrects the vulnerability.

In most cases, the revision 88 involves the application of a vendor-supplied patch, overwriting an existing configuration file with a revised version, and so forth. As such, the revisions 88 may involve large volumes of data consisting of numerous files that may not necessarily be suitable for storage in the security policy 82, or within the vulnerability assessment system 76. A list of the revisions 88 may be kept in a solutions inventory 92 that specifies the location from which the corresponding revision 88 to the vulnerability definition may be retrieved, along with other miscellaneous information that may be helpful to the system administrator.

Although some of the revisions 88 may be stored in the vulnerability assessment system 76, in most cases the revisions 88 are downloaded as necessary depending upon the preexisting vulnerabilities 84 specific to the virtual machine 52 being scanned. It is understood that the guest operating system 54 and the applications 56 have self-update features. As utilized herein, the application of the revision 88 is understood to refer to the transfer of the revision 88 from the update module 90 to the virtual machine 52, and running such self-update features thereon with the revision 88 to be applied.

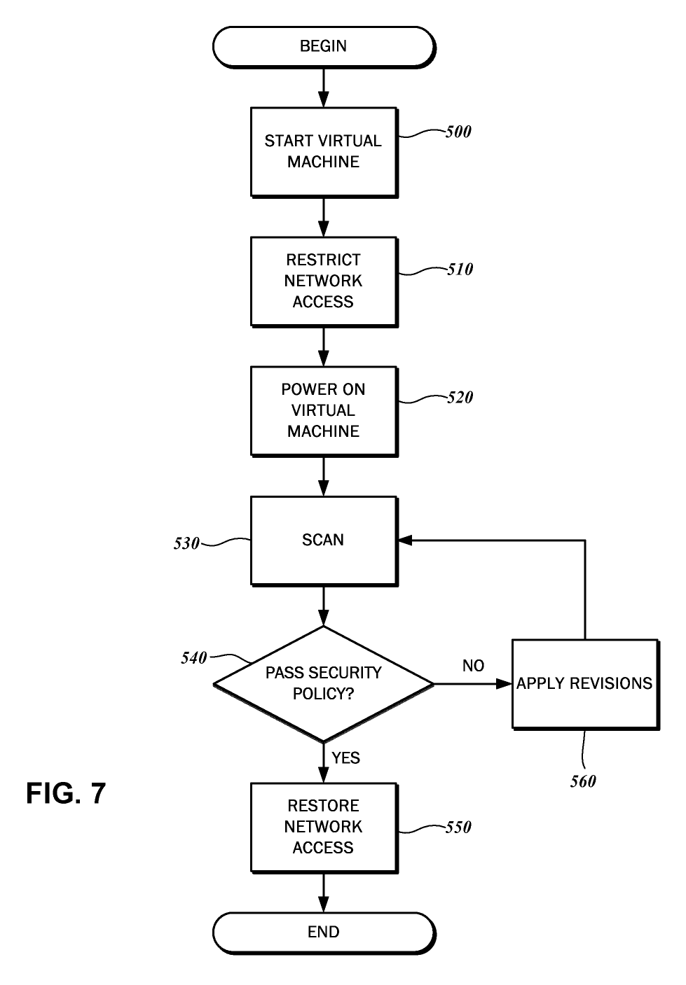

Upon completing the application of the revision 88 to the virtual machine 52, network connectivity thereof may be immediately restored, or another vulnerability query as in step 420 may be initiated. In the latter case, the vulnerability query may be re-run until the virtual machine 52 passes the security policy 82. Referring to the flowchart of FIG. 7, a broader overview of the method according to one embodiment of present invention is illustrated. Beginning with step 500, which corresponds in part to step 400, the virtual machine 52 is started. As the virtual machine 52 is started, network access thereby is restricted according to step 510. It is understood that step 410 corresponds in part to the step 510. The virtual machine 52 is operational in step 520, and the vulnerability assessment system 76 initiates a scanning step 530. If the scanning step 530 finds that the virtual machine 52 passes the security policy 82 as determined in decision block 540, the method continues with restoring network access in step 550, and the method concludes. If, however, the scanning step 530 finds that the virtual machine 52 fails the security policy 82 (decision block 540), the method then commences the application of revisions 88 in step 560. After completing step 560, according to one embodiment of the present invention as noted above, the method returns to step 530 in order to scan the virtual machine 52 again. The loop involving the application of the revisions 88 and re-scanning in step 530 is contemplated to ensure that all necessary updates are applied, as some individual updates may restart the virtual machine 52 independently (e.g., operating system updates that require restart).

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention with more particularity than is necessary for the fundamental understanding of the present invention, the description taken with the drawings making apparent to those skilled in the art how the several forms of the present invention may be embodied in practice.

What is claimed is:

1. A method for securing a virtual machine on a host system, the method comprising:
intercepting an initiation signal from the host system generated upon startup of the virtual machine, a network connection on the host system being accessible by the virtual machine to communicate over a network;
restricting the network connection to the virtual machine in response to the initiation signal;
querying the virtual machine for preexisting vulnerabilities;
receiving the preexisting vulnerabilities from the virtual machine; and
controlling access by the virtual machine to the network connection on the host system based upon a comparison of a security policy to the received preexisting vulnerabilities, the security policy including vulnerability definitions associated with the virtual machine.

2. The method of claim 1, wherein controlling access includes restricting the virtual machine from accessing selected segments of the network through the network connection, and the received preexisting vulnerabilities are matched to at least one of the vulnerability definitions in the security policy.

3. The method of claim 2, further comprising:
initiating the application of revisions to the virtual machine, the revisions being associated with the received preexisting vulnerabilities.

4. The method of claim 1, wherein controlling access includes permitting the virtual machine to access the network connection, and the virtual machine has a lack of received preexisting vulnerabilities matched to at least one of the vulnerability definitions of the security policy.

5. The method of claim 1, wherein:
the preexisting vulnerabilities each has an assigned criticality level; and
the security policy further includes criticality levels corresponding to each of the vulnerability definitions and a combined threshold criticality level.

6. The method of claim 5, wherein controlling access includes restricting the virtual machine from accessing selected segments of the network through the network connection, a tally combining the criticality levels corresponding to matched ones of the received preexisting vulnerabilities exceeding the combined threshold criticality level.

7. The method of claim 5, wherein controlling access includes permitting the virtual machine to access the network connection, and a tally combining the criticality levels corresponding to the matched ones of the received preexisting vulnerabilities are less than the combined threshold criticality level.

8. The method of claim 5, wherein a first criticality level is assigned to a first one of the vulnerability definitions and a different second criticality level is assigned to a second one of the vulnerability definitions.

9. The method of claim 1, wherein the virtual machine is queried for preexisting vulnerabilities while the network connection to the virtual machine is restricted.

10. The method of claim 1, wherein after querying the virtual machine, the method includes generating a report of the discovered preexisting vulnerabilities of the virtual machine.

11. The method of claim 1, wherein a security audit module independent of the virtual machine queries the virtual machine for preexisting vulnerabilities.

12. The method of claim 11, wherein the security audit module runs on a remote system in network communication with the host system.

13. The method of claim 11, wherein the security audit module runs on the host system.

14. A virtual machine vulnerability assessment system comprising:
a monitor module in communication with a host system for a virtual machine, the host system being in communication with the virtual machine, and a startup signal being receivable by the monitor module at the instantiation of the virtual machine;
a scanning engine activatable by the monitor module, the scanning engine being in communication with the virtual machine to detect vulnerabilities of the virtual machine;
a security policy associated with the scanning engine and including a plurality of vulnerability definitions; and
a policy execution module in communication with the scanning engine, access to the network interface from the virtual machine being controlled based upon a correlation of the detected vulnerabilities to the vulnerability definitions.

15. The virtual machine vulnerability assessment system of claim 14 wherein:
the monitor module is in communication with the policy execution module; and
access to the network interface from the virtual machine is restricted to a network segment of the base system by the monitor module in response to the startup signal.

16. The virtual machine vulnerability assessment system of claim 14, further comprising an update module in communication with the policy execution module, revisions to the virtual machine addressing the detected vulnerabilities being applied to the virtual machine by the update module.

17. The virtual machine vulnerability assessment system of claim 14, wherein:
the host system is in communication with the virtual machine over a network interface; and
the scanning engine is in communication with the virtual machine over the network interface.

18. The virtual machine vulnerability assessment system of claim 14, wherein the scanning engine is in communication with the virtual machine over a local interface in a memory of the host system.

19. The virtual machine vulnerability assessment system of claim 14, wherein the base system includes a virtual machine manager for generating the startup signal and managing access to the network interface.

20. The virtual machine vulnerability assessment system of claim 14, wherein the monitor module, the scanning engine, and the policy execution module reside on the host system.

21. The virtual machine vulnerability assessment system of claim 14, wherein the monitor module, the scanning engine, and the policy execution module reside in a remote system in communication with the host system.

22. The virtual machine vulnerability assessment system of claim 14, wherein the known vulnerability identifiers each have a severity level associated therewith, the security policy configuration defining a maximum threshold level of detected vulnerabilities.

23. A computer readable medium having computer-executable instructions for performing a method for securing a virtual machine on a host system, the method comprising:
intercepting an initiation signal from the host system generated upon startup of the virtual machine, a network connection on the host system being accessible by the virtual machine;
restricting the network connection to the virtual machine in response to the initiation signal;
querying the virtual machine for preexisting vulnerabilities;
receiving the preexisting vulnerabilities from the virtual machine;
controlling access by the virtual machine to the network connection on the host system based upon a comparison of a security policy to the received preexisting vulnerabilities, the security policy including vulnerability definitions associated with the virtual machine.
